(19) United States
(12) Patent Application Publication
(10) Pub. No.: US 2005/0021661 A1
(43) Pub. Date: Jan. 27, 2005

(54) Directory request caching in distributed computer systems

(76) Inventors: Sylvain Duloutre, Fontaine (FR); Jerome Arnou, D'Heres (FR)

Correspondence Address: OSHA & MAY L.L.P./SUN, 1221 MCKINNEY, SUITE 2800, HOUSTON, TX, 77010, US

(21) Appl. No.: 10/494,089

(22) PCT Filed: Nov. 1, 2001
(86) PCT No.: PCT/IB01/02063

(51) Int. Cl. G06F 15/16; G06F 7/00

(52) U.S. Cl. 709/217; 707/3

(57) ABSTRACT

The invention concerns a directory server component, for use with a request query (420) adapted to receive an input request from a client (100) and to retrieve corresponding result data from a database (302). This directory server component comprises a cache manager (240) for storing sets of data, each set of data comprising request identifying data and corresponding result data. This directory server component also comprises a request manger (410), responding to an input request, for searching request identifying data that match the input request, and subsequently for deciding whether result data in the sets of data will be at least partially used to answer the request.

This invention relates to distributed computer systems.

In certain fields of technology, e.g. a Web network, a complete system may include a diversity of equipments from various types and manufacturers. This is true not only at the hardware level, but also at the software level.

Network users (“client components”) need to have access, upon query, to a large number of data (“application software components”) making it possible for the network users to create their own dynamic web site or to consult a dynamic web site, for example an e-commerce site on a multi platform computer system (Solaris, Windows NT, AIX, HPUX . . . ).

These queries are directed to a directory, e.g. an LDAP directory, and managed by a directory server. It is desirable that this access to a large number of data be rendered as fast and efficient as possible.

A general aim of the present invention is to provide advances in these directions.

Thus, this invention offers a directory server component, for use with a request query adapted to receive an input request from a client and to retrieve corresponding result data from a data base, said directory server component comprising:
a cache manager capable of storing sets of data, each set of data comprising request identifying data and corresponding result data and
a request manager, capable of responding to an input request for searching request identifying data that match the input request, and of subsequently deciding whether result data in said sets of data will be at least partially used to answer the request.

On another hand, this invention also offers a method of processing requests in a directory server system, comprising the following steps:
a. storing sets of data in a cache memory, said sets of data comprising request identifying data and corresponding result data, and
b. responsive to an input request received from a client, deciding whether result data in said sets of data will be used to serve the input request.

Step b. may e.g. comprise determining from the request identifying data whether the cache contains results that match the input request. However, the decision may also be based on different criteria, e.g. a decision that the input request is not, as a whole, (or not at all) of a kind to be found in the cache. Furthermore, the input request may also be divided into two or more sub-requests, which are processed like the input request.

The method may further comprise one or more of the following steps:
c. at least partially executing the request, to retrieve those of the results that are not obtained from result data in said sets of data;
d. pursuant to step c. deciding whether to store the results being retrieved as new sets of data in the cache.

This invention may also be defined as an apparatus or system and/or software code for implementing the method, in all its alternative embodiments to be described hereinafter.

Other alternative features and advantages of the invention will appear in the detailed description below and in the appended drawings, in which:

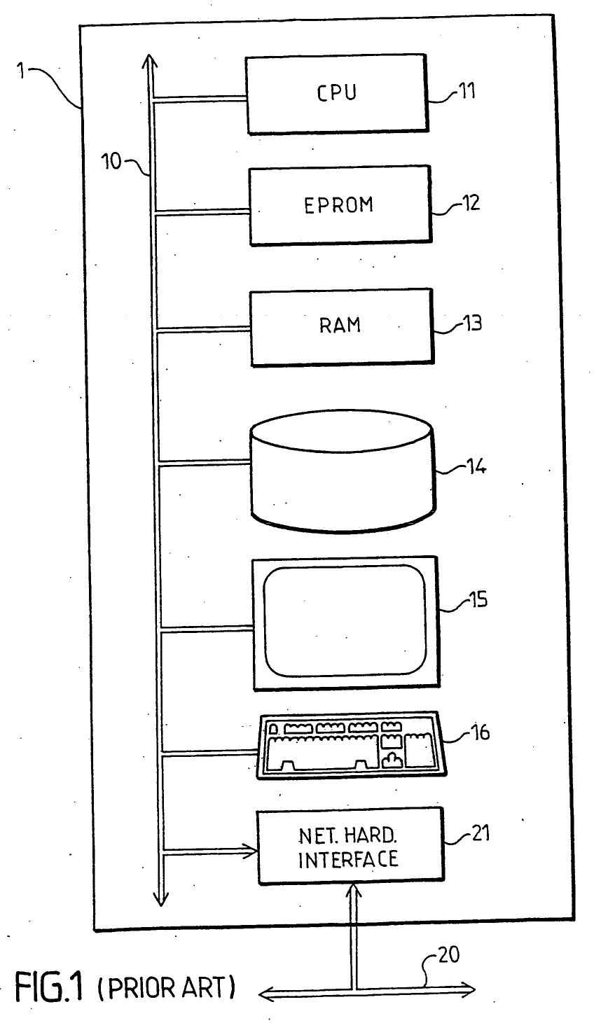

FIG. 1 is a general diagram of a computer system in which the invention is applicable;

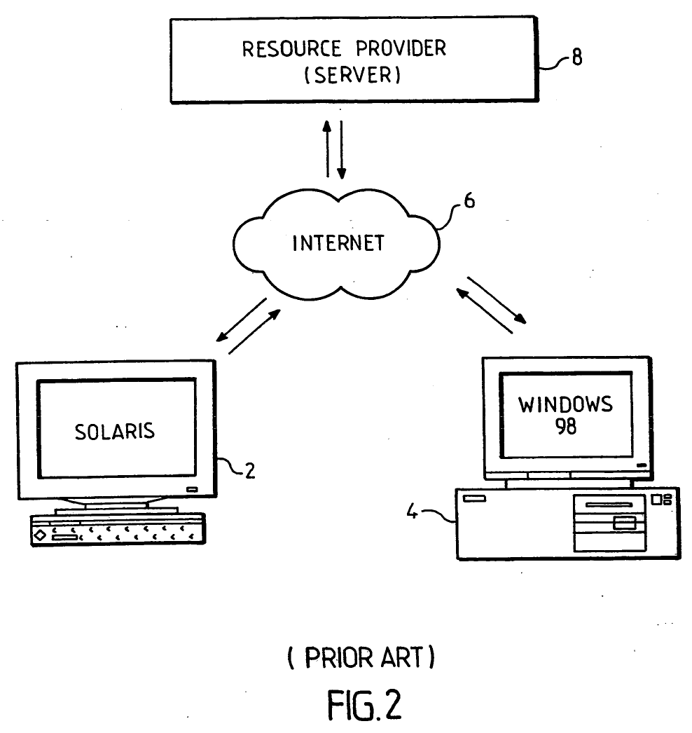

FIG. 2 illustrates a multiple platform environment;

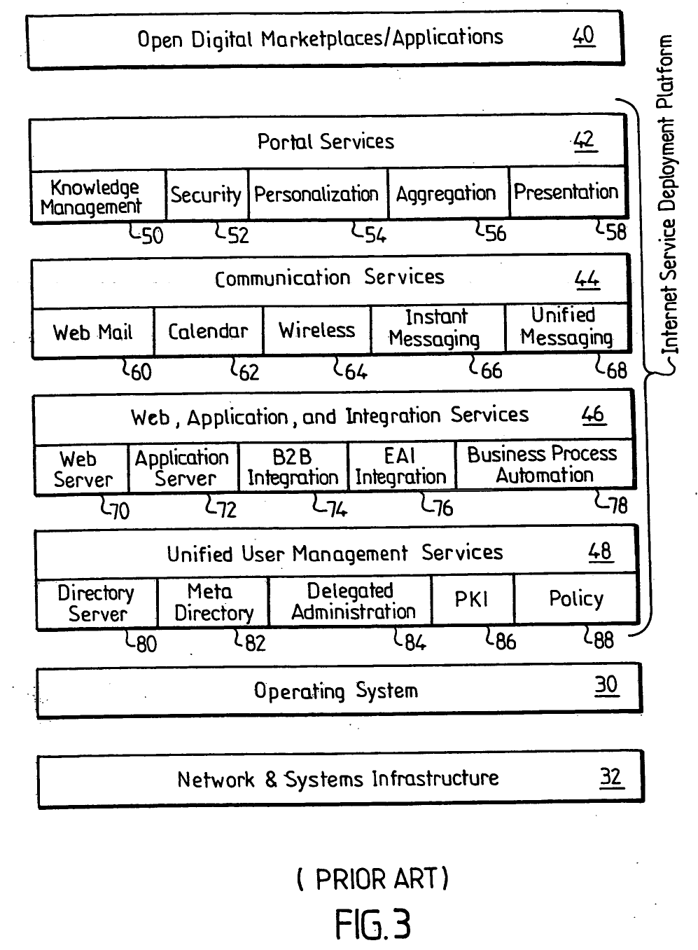

FIG. 3 illustrates a block diagram of iPlanet™ Internet Service Development Platform;

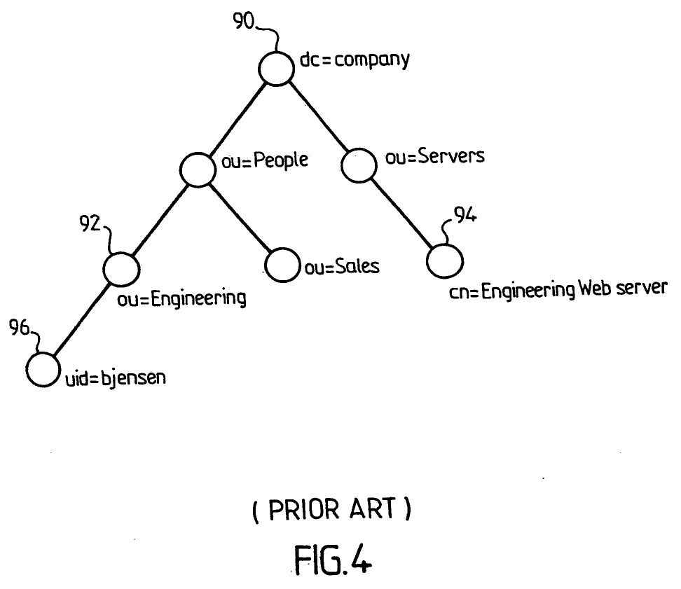

FIG. 4 illustrates part of a typical directory;

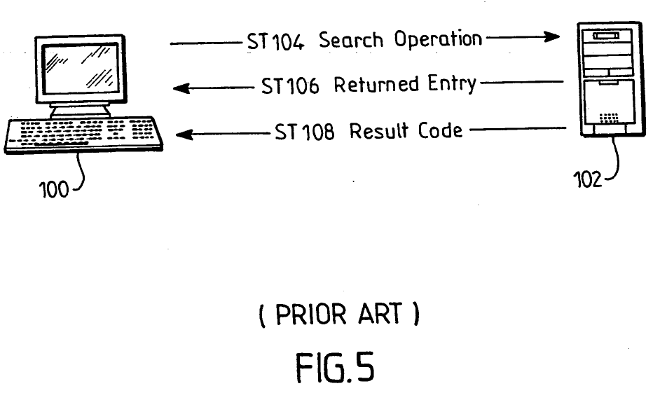

FIG. 5 illustrates LDAP protocol used for a simple request;

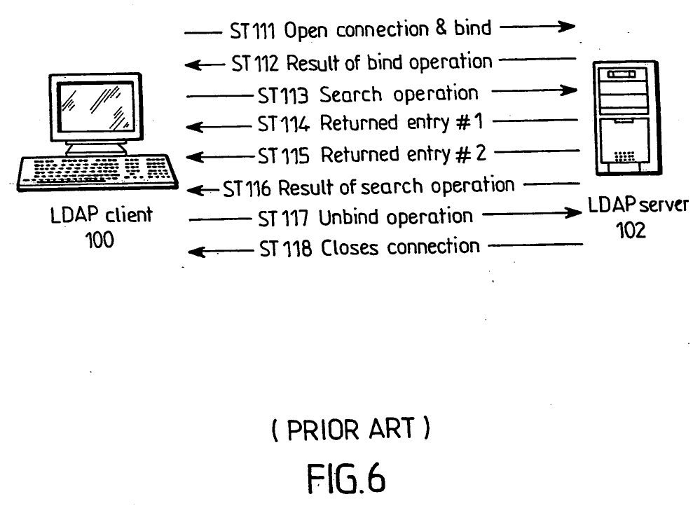

FIG. 6 illustrates a typical LDAP exchange between the LDAP client and LDAP server;

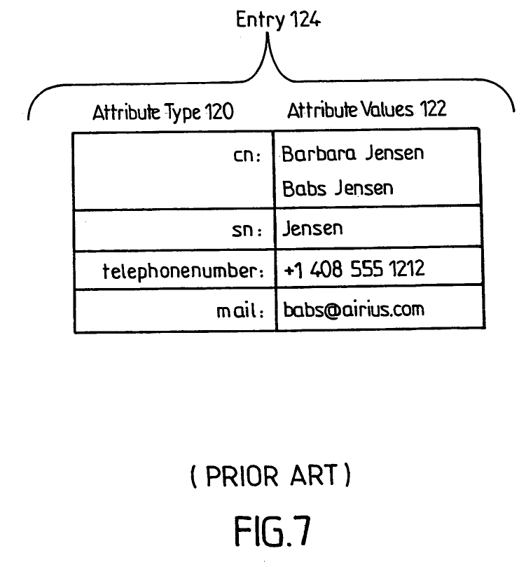

FIG. 7 illustrates a directory entry showing attribute types and values;

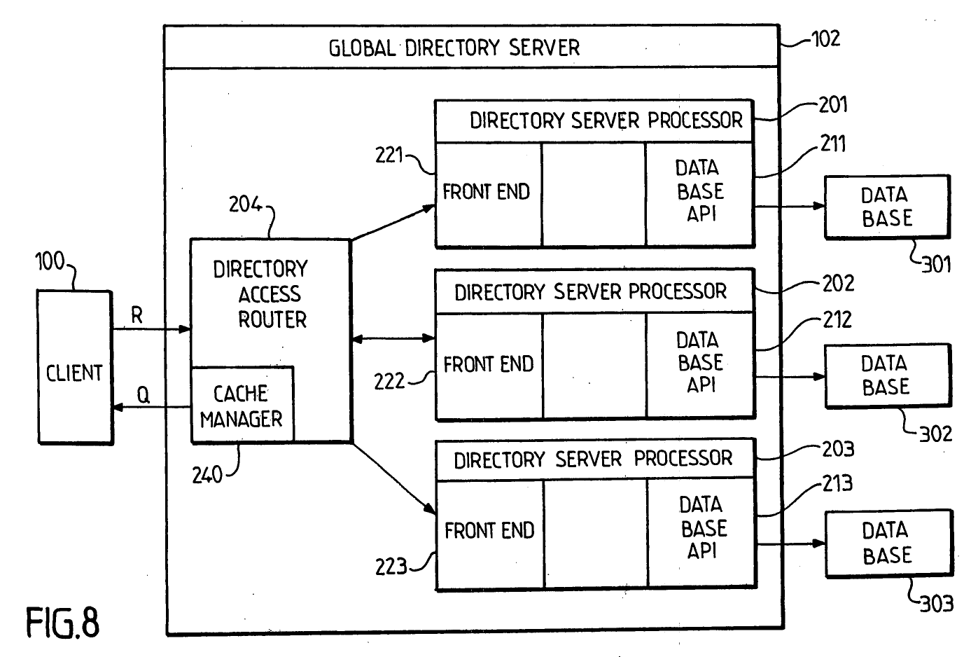

FIG. 8 illustrates a client to data base structure according to the invention;

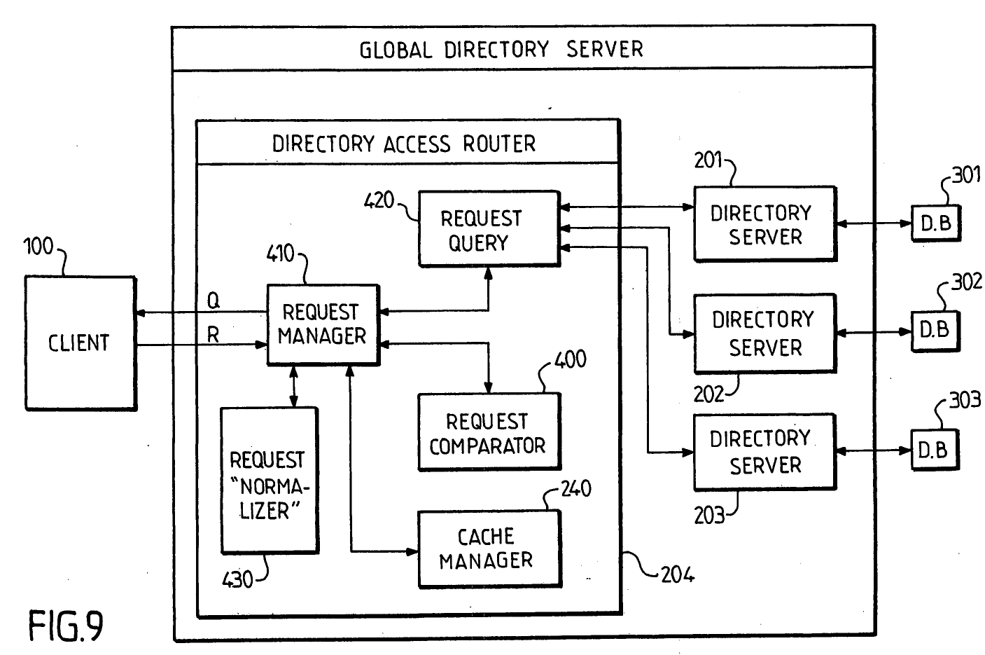

FIG. 9 illustrates a client to data base structure according to the invention;

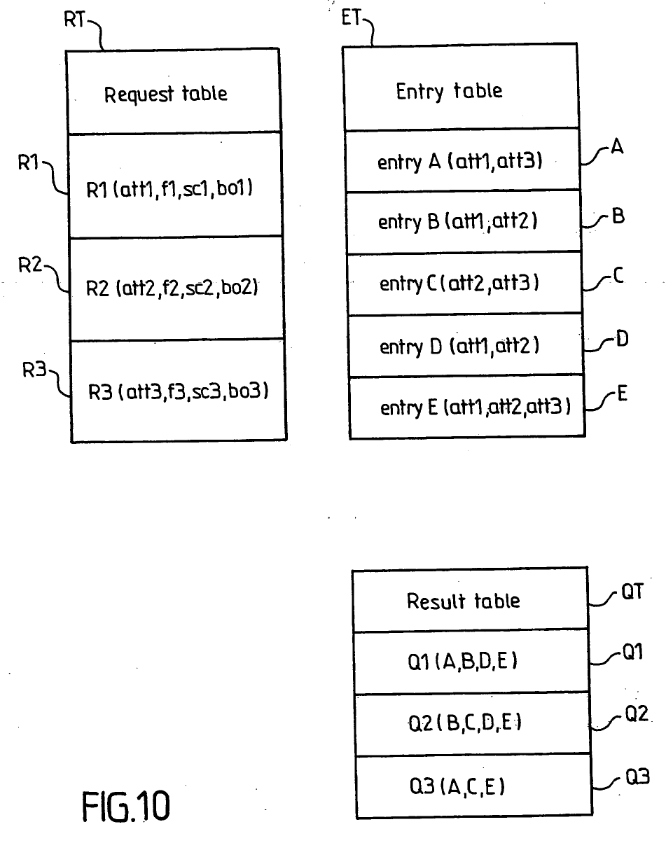

FIG. 10 illustrates an exemplary structure of the data according to the invention.

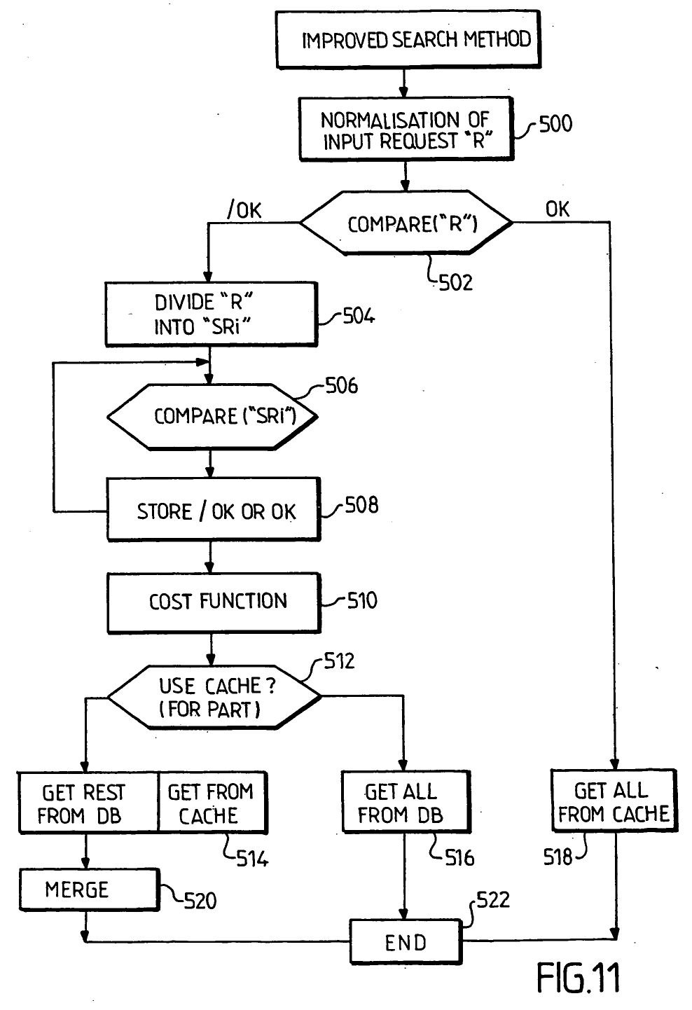

FIG. 11 illustrates a flow-chart of the improved search method according to the invention;

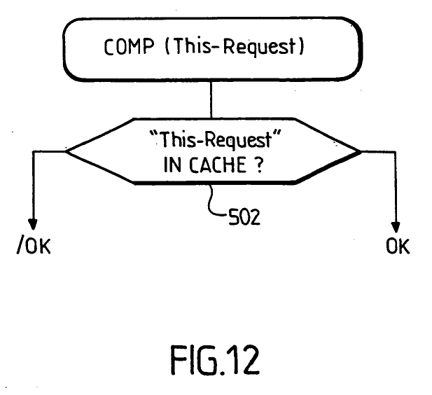

FIG. 12 illustrates a part of flow-chart of the improved search method according to the invention.

Additionally, the detailed description is supplemented with the following Exhibits:
Exhibit E1 contains examples of elements used in a LDAP environment.

In the foregoing description, references to the Exhibits are made directly by the Exhibit or Exhibit section identifier: for example, E1-e1 refers to section e1 in Exhibit E1. The Exhibits are placed apart for the purpose of clarifying the detailed description, and of enabling easier reference. They nevertheless form an integral part of the description of the present invention. This applies to the drawings as well.

As cited in this specification, Sun, Sun Microsystems, Solaris, iPlanet are trademarks of Sun Microsystems, Inc. SPARC is a trademark of SPARC International, Inc.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright and/or author's rights whatsoever.

Now, making reference to software entities imposes certain conventions in notation. For example, in the detailed description, Italics (or the quote sign “) may be used when deemed necessary for clarity.

However, in code examples:
quote signs are used only when required in accordance with the rules of writing code, i.e. for string values.
an expression framed with square brackets, e.g. [property=value]* is optional and may be repeated if followed by *;
a name followed with [ ] indicates an array.

Also, <attribute> may be used to designate a value for the attribute named “attribute” (or attribute).

This invention may be implemented in a computer system, or in a network comprising computer systems. The hardware of such a computer system is for example as shown in FIG. 1, where:
11 is a processor, e.g. an Ultra-Sparc;
12 is a program memory, e.g. an EPROM for BIOS, a RAM, or Flash memory, or any other suitable type of memory;
13 is a working memory, e.g. a RAM of any suitable technology (SDRAM for example);
14 is a mass memory, e.g. one or more hard disks;
15 is a display, e.g. a monitor;
16 is a user input device, e.g. a keyboard and/or mouse; and
21 is a network interface device connected to a communication medium 20, itself in communication with other computers. Network interface device 21 may be an Ethernet device, a serial line device, or an ATM device, inter alia. Medium 20 may be based on wire cables, fiber optics, or radio-communications, for example.

Data may be exchanged between the components of FIG. 1 through a bus system 10, schematically shown as a single bus for simplification of the drawing. As is known, bus systems may often include a processor bus, e.g. of the PCI type, connected via appropriate bridges to e.g. an ISA bus and/or an SCSI bus.

Prior art FIG. 2 illustrates a conceptual arrangement wherein a first computer 2 running the Solaris platform and a second computer 4 running the Windows 98™ platform are connected to a server 8 via the Internet 6. A resource provider using the server 8 might be any type of business, governmental, or educational institution. The resource provider 8 needs to be able to provide its resources to both the user of the Solaris platform and the user of the Windows 98™ platform, but does not have the luxury of being able to custom design its content for the individual traditional platforms. Effective programming at the application level requires the platform concept to be extended all the way up the stack, including all the new elements introduced by the Internet. Such an extension allows application programmers to operate in a stable, consistent environment.

iPlanet E-commerce Solutions, a Sun Microsystems|Netscape Alliance, has developed a “net-enabling” platform shown in FIG. 3 called the Internet Service Deployment Platform (ISDP) 28. ISDP 28 gives businesses a very broad, evolving, and standards-based foundation upon which to build a solution enabling a network service.

ISDP (28) incorporates all the elements of the Internet portion of the stack and joins the elements seamlessly with traditional platforms at the lower levels. ISDP (28) sits on top of traditional operating systems (30) and infrastructures (32). This arrangement allows enterprises and service providers to deploy next generation platforms while preserving “legacy-system” investments, such as a mainframe computer or any other computer equipment that is selected to remain in use after new systems are installed.

ISDP (28) includes multiple, integrated layers of software that provide a full set of services supporting application development, e.g., business-to-business exchanges, communications and entertainment vehicles, and retail Web sites. In addition, ISDP (28) is a platform that employs open standards at every level of integration enabling customers to mix and match components. ISDP (28) components are designed to be integrated and optimized to reflect a specific business need. There is no requirement that all solutions within the ISDP (28) are employed, or any one or more is exclusively employed.

In a more detailed review of ISDP (28) shown in FIG. 3, the iPlanet deployment platform consists of the several layers. Graphically, the uppermost layer of ISDP (28) starts below the Open Digital Marketplace/Application strata (40).

The uppermost layer of ISDP (28) is a Portal Services Layer (42) that provides the basic user point of contact, and is supported by integration solution modules such as knowledge management (50), personalization (52), presentation (54), security (56), and aggregation (58).

Next, a layer of specialized Communication Services (44) handles functions such as unified messaging (68), instant messaging (66), web mail (60), calendar scheduling (62), and wireless access interfacing (64).

A layer called Web, Application, and Integration Services (46) follows. This layer has different server types to handle the mechanics of user interactions, and includes application and Web servers. Specifically, iPlanet™ offers the iPlanet™ Application Server (72), Web Server (70), Process Manager (78), Enterprise Application and Integration (EAI) (76), and Integrated Development Environment (IDE) tools (74).

Below the server strata, an additional layer called Unified User Management Services (48) is dedicated to issues surrounding management of user populations, including Directory Server (80), Meta-directory (82), delegated administration (84), Public Key Infrastructure (PKI) (86), and other administrative/access policies (88). The Unified User Management Services layer (48) provides a single solution to centrally manage user account information in extranet and e-commerce applications. The core of this layer is iPlanet™ Directory Server (80), a Lightweight Directory Access Protocol (LDAP)-based solution that can handle more than 5,000 queries per second.

iPlanet Directory Server (iDS) provides a centralized directory service for an intranet or extranet while integrating with existing systems. The term directory service refers to a collection of software, hardware, and processes that store information and make the information available to users. The directory service generally includes at least one instance of the iDS and one or more directory client programs. Client programs can access names, phone numbers, addresses, and other data stored in the directory.

One common directory service is a Domain Name System (DNS) server. The DNS server maps computer host names to IP addresses. Thus, all of the computing resources (hosts) become clients of the DNS server. The mapping of host names allows users of the computing resources to easily locate computers on a network by remembering host names rather than numerical Internet Protocol (IP) addresses. The DNS server only stores two types of information, but a typical directory service stores virtually unlimited types of information.

The iDS is a general-purpose directory that stores all information in a single, network-accessible repository. The iDS provides a standard protocol and application programming interface (API) to access the information contained by the iDS.

The iDS provides global directory services, meaning that information is provided to a wide variety of applications. Until recently, many applications came bundled with a proprietary database. While a proprietary database can be convenient if only one application is used, multiple databases become an administrative burden if the databases manage the same information. For example, in a network that supports three different proprietary e-mail systems where each system has a proprietary directory service, if a user changes passwords in one directory, the changes are not automatically replicated in the other directories. Managing multiple instances of the same information results in increased hardware and personnel costs.

The global directory service provides a single, centralized repository of directory information that any application can access. However, giving a wide variety of applications access to the directory requires a network-based means of communicating between the numerous applications and the single directory. The iDS uses LDAP to give applications access to the global directory service.

LDAP is the Internet standard for directory lookups, just as the Simple Mail Transfer Protocol (SMTP) is the Internet standard for delivering e-mail and the Hypertext Transfer Protocol (HTTP) is the Internet standard for delivering documents. Technically, LDAP is defined as an on-the-wire bit protocol (similar to HTTP) that runs over Transmission Control Protocol/Internet Protocol (TCP/IP). LDAP creates a standard way for applications to request and manage directory information.

X.500 and X.400 are the corresponding Open Systems Interconnect (OSI) standards. LDAP supports X.500 Directory Access Protocol (DAP) capabilities and can easily be embedded in lightweight applications (both client and server) such as email, web browsers, and groupware. LDAP originally enabled lightweight clients to communicate with X.500 directories. LDAP offers several advantages over DAP, including that LDAP runs on TCP/IP rather than the OSI stack, LDAP makes modest memory and CPU demands relative to DAP, and LDAP uses a lightweight string encoding to carry protocol data instead of the highly structured and costly X.500 data encoding.

An LDAP-compliant directory, such as the iDS, leverages a single, master directory that owns all user, group, and access control information. The directory is hierarchical, not relational, and is optimized for reading, reliability, and scalability. This directory becomes the specialized, central repository that contains information about objects and provides user, group, and access control information to all applications on the network. For example, the directory can be used to provide information technology managers with a list of all the hardware and software assets in a widely spanning enterprise. Most importantly, a directory server provides resources that all applications can use, and aids in the integration of these applications that have previously functioned as stand-alone systems. Instead of creating an account for each user in each system the user needs to access, a single directory entry is created for the user in the LDAP directory.

FIG. 4 shows a portion of a typical directory with different entries corresponding to real-world objects. The directory depicts an organization entry (90) with the attribute type of domain component (dc), an organizational unit entry (92) with the attribute type of organizational unit (ou), a server application entry (94) with the attribute type of common name (cn), and a person entry (96) with the attribute type of user ID (uid). All entries are connected by the directory.

Understanding how LDAP works starts with a discussion of an LDAP protocol. The LDAP protocol is a message-oriented protocol. The client constructs an LDAP message containing a request and sends the message to the server. The server processes the request and sends a result, or results, back to the client as a series of LDAP messages. Referring to FIG. 5, when an LDAP client (100) searches the directory for a specific entry, the client (100) constructs an LDAP search request message and sends the message to the LDAP server (102) (operation ST 104). The LDAP server (102) retrieves the entry from the database and sends the entry to the client (100) in an IDAP message (operation ST 106). A result code is also returned to the client (100) in a separate LDAP message (operation ST 108).

LDAP-compliant directory servers like the iDS have nine basic protocol operations, which can be divided into three categories. The first category is interrogation operations, which include search and compare operators. These interrogation operations allow questions to be asked of the directory. The LDAP search operation is used to search the directory for entries and retrieve individual directory entries. No separate LDAP read operation exists. The second category is update operations, which include add, delete, modify, and modify distinguished name (DN), i.e., rename, operators. A DN is a unique, unambiguous name of an entry in LDAP. These update operations allow the update of information in the directory. The third category is authentication and control operations, which include bind, unbind, and abandon operators.

The bind operator allows a client to identify itself to the directory by providing an identity and authentication credentials. The DN and a set of credentials are sent by the client to the directory. The server checks whether the credentials are correct for the given DN and, if the credentials are correct, notes that the client is authenticated as long as the connection remains open or until the client re-authenticates. The unbind operation allows a client to terminate a session. When the client issues an unbind operation, the server discards any authentication information associated with the client connection, terminates any outstanding LDAP operations, and disconnects from the client, thus closing the TCP connection. The abandon operation allows a client to indicate that the result of an operation previously submitted is no longer of interest. Upon receiving an abandon request, the server terminates processing of the operation that corresponds to the message ID.

In addition to the three main groups of operations, the LDAP protocol defines a framework for adding new operations to the protocol ia LDAP extended operations. Extended operations allow the protocol to be extended in an orderly manner to meet new marketplace needs as they emerge.

A typical complete LDAP client/server exchange might proceed as depicted in FIG. 6. First, the LDAP client (100) opens a TCP connection to the LDAP server (102) and submits the bind operation (operation ST 111). This bind operation includes the name of the directory entry that the client wants to authenticate as, along with the credentials to be used when authenticating. Credentials are often simple passwords, but they might also be digital certificates used to authenticate the client (100). After the directory has verified the bind credentials, the directory returns a success result to the client (100) (operation ST 112). Then, the client (100) issues a search request (operation ST 113). The LDAP server (102) processes this request, which results in two matching entries (operation STs 114 and 115). Next, the LDAP server (102) sends a result message (operation ST 116). The client (100) then issues the unbind request (operation ST 117), which indicates to the LDAP server (102) that the client (100) wants to disconnect. The LDAP server (102) obliges by closing the connection (operation ST 118).

By combining a number of these simple LDAP operations, directory-enabled clients can perform useful, complex tasks. For example, an electronic mail client can look up mail recipients in a directory, and thereby, help a user address an e-mail message.

The basic unit of information in the LDAP directory is an entry, a collection of information about an object. Entries are composed of a set of attributes, each of which describes one particular trait of an object. Attributes are composed of an attribute type (e.g., common name (cn), surname (sn), etc.) and one or more values. FIG. 7 shows an exemplary entry (124) showing attribute types (120) and values (122). Attributes may have constraints that limit the type and length of data placed in attribute values (122). A directory schema places restrictions on the attribute types (120) that must be, or are allowed to be, contained in the entry (124).

Reference is now made to FIG. 8, which shows an exemplary embodiment of this invention.

In FIG. 8, a client 100 accesses data bases 301, 302, 303 through a global directory server entity 102. The global directory server 102 may comprise a Directory Access Router 204 and directory servers 201, 202, 203. The directory servers comprise a request processing function, or request query processor (in short “request query”), in charge of receiving an input request (coming from a client) and of retrieving the corresponding result data from one or more of the data bases. In addition, in the prior art, one or more of directory servers 201 through 203 may also include a physical cache.

In FIG. 8, when a client sends an LDAP search request, it firstly reaches a Directory Access Router 204. Alternatively, a search request might be directly sent to “proximal” directory servers 201 through 203. The expression “proximal directory server” refers here to the directory servers as such, i.e. those that are in charge of interrogating the data bases to obtain the result of a request, in contrast with a more extended or global Directory Server System, including e.g. Directory Access Routers.

The Directory Access Router manages an access to each directory server through the front end 221, 222, 223 of that directory server. Each directory server 201, 202, 203 may comprise a data base API furnishing an interface 211, 212, 213 to enable an LDAP search request to access respectively the data bases 301, 302, 303 as described hereinbefore.

These directory servers and their respective data bases may be in a specific protected zone, also termed “militarized zone”, designating a zone whose access is authorized subject to given security conditions. The Directory Access Router (e.g. the IPlanet Directory Access Router, IDAR) is adapted to control access of client 100 to such a “militarized zone”, if any. Moreover, the Directory Access Router may be arranged to manage a fail over in the directory servers.

In the exemplary embodiment, the Directory Access Router 204 comprises a cache manager 240. (Alternatively, or in addition, one or more of directory servers 201 through 203 may also include a cache manager, for processing search requests being directly sent to them).

FIG. 9 shows an exemplary embodiment of the global directory server 102 in more detail.

In FIG. 9, the directory access router 204 comprises, in addition to the cache manager 240: a request query 420, a request manager 410, and a request comparator 400. These three functionalities are considered separately for clarity; however, they may be imbricated, at least partially. For example, the request comparator 400 may be part of the request manager 410; also, the functionalities of the request manager 410 and of the request query 420 may be gathered into a single module.

The request query 420 is in charge of sending a request to one or more of directory servers 201-203 for executing the request, as known.

The cache manager 240 provides memory allocation for storing sets of data, which comprise requests, linked to their results, as it will be described hereinafter.

When a client 100 sends an input request R, the request manager 410 may firstly feed that request to the request comparator 400. Generally, the request comparator 400 will provide a comparison between a request it receives and the request identifying data, as they exist in the sets of data in the cache manager 240. The comparison is considered successful if the request as fed to the comparator entirely matches a request as defined by request identifying data (“cached requests”) in the cache manager 240. (Partial matching, and/or matching with several request identifying data, may also be considered).

The comparator 400 provides the result of the comparison to the request manager 410. An evaluation of the complexity of the search being required to retrieve the result in the cache manager may also be performed. This may be done by the request manager 410, by the request comparator 400, or in cooperation between them.

In fact, assuming the input request exactly matches request identifying data (a “cached request”), the request manager 410 will simply return the result data (“cached results”) corresponding to these request identifying data. However, this is not likely to happen all the times.

In the opposite, when comparator 400 finds no match in the cache manager 240, then the request manager 410 will send the input request to the request query 420, which directly or indirectly interrogates the data base(s), so as to retrieve the results corresponding to the request, as known.

An evaluation of the complexity of the processing being required to retrieve the result in the data base(s) may also be performed. This may be done by the request manager 410, by the request query processor 420, or in cooperation between them.

The above is a simple version of a logical decision, made by the request manager 410, responsive to a comparison made by the comparator (and to the evaluation of complexity, if appropriate).

This invention may only implement the above functionalities. However, it may also consider more complicated cases, as it will now be described.

For example, the request manager 410 may be arranged to inspect the incoming client request. When so doing, it may simply decide that the request has no chance to exist in the cache manager, e.g. because the request is too complicated (too broad), or very unusual. This may be based on predetermined criteria (and on the request normalization, to be described). This is another kind of logical decision.

The logical decision may also encompass more complicated cases.

For example, a comparison as made by the request comparator 400 may be partially successful, meaning that a request partially matches request identifying data, or successful by parts, meaning that several request identifying data may be used to match the request.

A way to obtain this is to divide the request in two or more complementary sub-requests. Then, the request identifying data in the cache manager 240 are searched to try and find matches with each of the sub-requests. The corresponding results may be retrieved from the cache manager.

The sub-division of a request may be made in the request manager 410 and/or in the request comparator 400. Although the use of complementary sub-requests may render the elaboration of the results simpler (there is no need to remove duplicates), overlapping sub-requests may be used as well.

Where a sub-request is not found in the cache manager 240, the request manager 410 may feed it to the request query processor 420 to get the results in the data bases.

Various algorithms may be used to determine how an input request is divided into sub-requests, and how many levels of division are admitted, if required. These algorithms may take various rules into account, including the actual contents of the cache manager, and the actual contents of the databases, and/or estimates of the same based on their structures. For example, indexing techniques may be used. As indicated, these functions may be shared between the request comparator 400 and the request manager 410. For example, indexes may be located in the request comparator 400, and used to orientate the sub-division of a request.

In a simple embodiment, the request manager 410 may be in charge of estimating which ones of the sub-requests may have their corresponding results in the cache manager, by passing each sub-request to the request comparator 400, individually. Pursuant to comparisons between the complementary sub-requests and the request identifying data, the request manager 410 then decides which ones of the complementary sub-requests may be answered using the cache manager 240, with the other ones of the complementary sub-requests having to be found in the data base(s), using the request query processor 420.

This decision may also be taken using other factors, e.g. pursuant to a comparison between an estimate of the complexity of doing the search using the cache and an estimate of the complexity of doing the search using the data base(s). This may involve the complexity of the request expression itself, and/or cost functions of doing the searches. Examples of cost functions will be described hereinafter.

Finally, whether they come from the request query processor 420 and/or from the request comparator 400, the results of the input query may be sent back to the client 100.

In the above, the functionalities of the modules 400, 240, 420 and 410 are described as located in one or more directory access routers; however, they may be located in the “proximal” directory servers 221 through 223 as well, or in both.

Prior art directory server(s) may have a physical cache memory to store some data more frequently exchanged between the “proximal” directory servers and the data bases. As known, such cache memory avoids repetitive accesses to the data bases, looking for the same data. However, in the known caches, the cache memory comprises unstructured data (the so-called “entries”), and such data have no clear or explicit connection with requests. Also, in the prior art, when the cache is full, a clean-up is made, in which older “entries” are somewhat randomly replaced by newer “entries”.

Moreover, in the prior art, when the directory server transmits the search request from the client to the data base, the “entries” are compared to the elements constituting the search request: {object base, scope, filter, attribute set}. The complete comparison has to be satisfied to retrieve the entries and to return them to the client. Thus, the physical cache may miss some entries for a search request, e.g. because the physical cache has been cleaned, thus rendering the physical cache inefficient, when answering the search request.

To sum up, prior art caches operate at the physical level of entries, thus potentially avoiding some disk accesses for certain entries in a given request, but do not permit to determine whether it is possible completely avoid disk access for a given request, or a portion thereof. With physical caches, request processing to up to the proximal directory servers is necessary in all cases. This results into a high load on these proximal directory servers, and in the network to access them.

By contrast, one aspect of this invention resides in caching both the search requests and their corresponding search results. A search request is more briefly designated as a “request” and the search result is designated as a “result” in the foregoing description.

Reference is now made to FIGS. 10 and 11.

In the LDAP example, a request is defined by the tuple {attributes, filter, scope, base}, e.g. R1 (att1, f1, sc1, bo1). The base object is the distinguished name (DN) on which the search is done. The scope is the “depth” of the search and may have e.g. the following values {base, one level, subtree}. The values of the scope may be coded as an integer or a string.

The filter comprises algebraic or logical operations as AND/OR/NOT/</>/˜, on attribute values.

The result corresponding to a request may be no entry, or, more frequently, a set of entries. Indeed, no entry is a valid result if no entry matches the filter and scope. As described before, each entry comprises an attribute list; for example, for entry A, the attribute list is (att1, att3). An attribute list may be empty.

As shown in the example of FIG. 10, the cache may comprise:
a first table or request table RT, containing e.g. requests R like {R1, R2, R3}, and
a second table or result table QT, containing the results Q corresponding to the requests R, e.g. results {Q1, Q2, Q3} for requests {R1, R2, R3}. Thus, for example, the result table QT associates at least the result Q1 to the request R1, e.g. by the fact each row in the result table includes one or more pointers to the request table, or conversely. As used here, the word “table” does not involve any particular physical organization of the data, i.e. a table may be physical (organized like a file) or logical.

Each request may have a (non empty) attribute list, which defines information to be included in the corresponding results, when found. It may happen that a new request corresponds to a cached request (existing in table RT), except that the attribute lists are different. This is a case of partial matching, in which the attributes missing in the cached request may be obtained e.g. from another cached request, or from interrogating the data base.

In a more specific embodiment of this invention, the cache manager 240 may also arrange for an entry table ET to be implemented in the cache. This table ET enables to share entries across results in the result table QT. Entries are thus stored in the table ET without being duplicated. A result in the result table QT may contain a list of references (or pointers) to entries physically stored in the entry table ET.

In other words, an entry in table ET indicates which result of a given request or results of given requests it corresponds to. Indeed, the attribute list of each entry in table ET represents the attributes of a given request it corresponds to, or the union of attributes of several given requests it corresponds to. For example, the attribute list (att1, att3) of entry A in FIG. 10 may form:
a portion of the results of the request R1 in table RT, having the attribute att1, and
a portion of the results of the request R3 in table RT, having the attribute att3.

It now appears that the unit of caching may be the result and the entry. Thus, data stored in the cache are accessible by results and by entries. A cached entry appears at least in one cached result of a cached request. For a cached request, all the entries representing the result of this cached request are in the cache. For example, the result of the request R1 is the union of the entries A, B, D, E, each having the attribute att1 in their attribute list.

Cache updating may be made from requests resulting into an interrogation of the data bases. Such requests may be client requests, and/or system requests, spontaneously decided e.g. by the request manager, on the basis if an estimate of most frequently targeted entries.

When the cache is full, clearance of the cache is performed while respecting the correspondence between the cached requests and their corresponding results.

In an embodiment, when the cache is full, the replacement unit is the result of the result table. This replacement unit enables to maintain all the entries corresponding to remaining results in the cache, contrary to prior art in which the replacement unit is an entry. Other cache updating schemes may be used as well, provided they maintain the correspondence between the cached requests and their corresponding results, or, at least, it remains possible from the cached information to determine whether all results corresponding to a cached request are present in the cache.

Such a storage of cached requests and results may considerably improve the efficiency of directory server systems, as it will be described in connection with the exemplary flow charts of FIGS. 11 and 12.

Those skilled in the art know that in many systems, there are several equivalent request expressions which define in fact the same request. For example requests e3 and e4 in Exhibit E1 are equivalent. Although it would be possible ignore equivalent requests when doing the comparison in request comparator 400, the cache is more efficient if equivalent requests are taken into consideration. This may be made e.g. by using a “request normalizer”, as shown at 430 in FIG. 9.

In an embodiment, the request normalizer 430 is called by the request processor 410:
a. before it sends a request or sub-request to request comparator 400, and
b. before it sends a request or sub-request executed through request query processor 420, for storage in the cache under control of the cache manager 240.
   Thus, the request identifying data in the cache manager 240 and the request or sub-requests submitted to comparator 400 have the same forms for all the possible equivalent requests, or, at least, for some of them.

Other interactions between the request normalizer 430 and modules 400, 410, and 240 may be used as well. Also, the request identifying data in the cache may have a form selected amongst different possibilities, ranging from the request expression as it stands natively, to a variety of compacted expressions thereof.

For example, assuming the requests are stored natively as request identifying data in the cache 240, the request normalizer may be used only at the level of comparator 400, for ultimately converting in a normalized version both the request to be compared and the request identifying data.

Storing the request identifying data in a normalized form in the cache avoids the need to convert the request identifying data repetitively before each comparison. In fact, a request to be stored in the cache may be first normalized, and then compacted before being cached. as request identifying data. In another alternative, a separate request normalizer (not shown) may be used to directly convert a request or sub-request into a normalized and compacted form, before storage in the cache.

Several different combinations of the above possibilities may also be contemplated.

A more detailed exemplary embodiment of this invention will now be described, with reference to FIG. 11.

Upon reception of a new request, the cache manager needs to check if this request corresponds to cached requests and thus can be answered from the associated cached results.

In the exemplary embodiment, a normalization may be applied to the request to enable the cache manager to compare the normalized request with the normalized cached request in operation 500. As the request is defined by the tuple {base object, scope, filter, attributes}, the normalization procedure may be applied to each of these elements. The normalization of distinguished name of the base object, the scope and the filter may be done on a format called “pivot”. The format is also called “canonical” for the attributes. There may exist different rules for normalizing such an element. The following description is based on Exhibit E1, which shows exemplary possible expressions of normalized elements according to possible different rules.

First of all, the base object of the request may be normalized. For example, a normalized distinguished name may be represented in normalized expressions, such as the normalized expressions E1-e1 and E1-e2. Then, such a normalized base object of request may be compared to the base object of cached requests for equality (the distinguished names are identical) and for containment (the distinguished names have some relative distinguished names in common up to the top).

The attributes of the request may also be normalized. For example, mixed names, oids or aliases used for attributes may be replaced by canonical attribute names. Moreover, the attribute set may be replaced by an attribute sequence with some ordering, e.g. alphabetical order. Examples of normalized attributes contained in a request are illustrated in the expressions E1-e3 and E1-e4.

A filter expression may be normalized using rules similar to the attribute normalization as illustrated in the expression E1-e5. Moreover, when combining operators, the filter expression may use a postfixed notation (Reverse Polish notation) as illustrated in the expression E1-e5.

Thus, in the improved search method, the normalization may be applied for the input request. Then, at operation 502, a compare ( ) function is called having in parameter the normalized request R. This function is developed in flow chart of FIG. 11.

At step 531, this function compares the request given as parameter to requests in the cache. The comparison between the input request and cached requests is based on the comparison of the elements defining a request. The comparison is first applied to the base object and the scope. Then, the more complicated comparison is applied to the filter. According to the result of this comparison, the compare( ) function sends back a variable OK for a positive answer or a variable /OK for a negative answer.

Thus, in step 502, the normalized request R is compared to the cached request.

If the compare( ) function sends back a variable OK, the request has been found in the cache. This variable OK may mean the following possibilities. If the request is strictly identical to the cached request, the result can be entirely retrieved from the cache at operation 518. Then, this result is returned to the client. The same action is done for a request semantically equivalent to a cached request. Moreover, if the request is more restrictive than a cached request, i.e. the request result is included in a cached result, this cached result is retrieved at operation 518 and the entries that do not match the search criteria are filtered out. In all of these cases, the scope and the filter are contained in a single cached request.

If the compare ( ) function sends back a variable /OK, results corresponding to both the scope and the filter are not in the cache, or are contained in several cached requests. The request R is decomposed into an appropriate number of sub-requests SR at operation 504.

At step 506, the compare( ) function is called repetitively for each sub-request SRi. During the comparison between a sub-request and cached requests in operation 506, it is checked if each sub-request has its result in the cache. A result is considered to be in the cache if the sub-request responds to the following criteria:
the sub-request is strictly identical to a cached request;
the sub-request is semantically equivalent to a cached request;
the sub-request is more restrictive than a cached request.
   At step 508, the comparison result OK or /OK may be stored for each sub-request.

“Cost functions” may be calculated at operation 510, to determine, for sub-requests, an estimate of the complexity to do a search using the cache. A “cost function” may be calculated according to, for example, one or more of the following factors:
number of sub-requests,
complexity of sub-requests, determined e.g. according to complexity of their filters (CPU power is required to evaluate filters),
result size of the sub-requests, determined according to the number of entry it contains.
   Costs functions related to sub-requests for a search in a data base are described e.g. at the following electronic reference
http:\\www.acm.org/pubs/citations/journals/tods/1988-13-3/p263-apers/.

The “cost functions” may be viewed as a way to estimate the time required when using the cache, which may then be compared to the time required to access directly the database (“direct access time”). Such comparison permits to determine the easier retrieval between cache and data base(s) for a sub-request.

Moreover, a direct access time is also calculated for the entire input request. At step 512, a comparison between this direct access time and an estimate of the time required for sub-requests, also called the cache “cost function”, permits to determine the best way to search between a search using the entire input request directly in the data base(s) or a search using sub-requests in the cache and eventually in data base(s).

If the direct access time is smaller than the cache “cost function”, the result Q is directly retrieved from the database using the entire input request, at operation 516. Else, according to the stored variables OK and /OK for each sub-request, sub-requests are either used directly in the data base(s) or used in the cache at step 514. Indeed, the result of the request can be at least partially obtained from the result of one or more cached requests corresponding to the sub-requests. The duplicated entries are removed and a final result is returned to the client. For example, the result of the sub-request SR1 is retrieved from the cached request R1 having its result Q1 and the result of the sub-request R4 is retrieved from the data base in FIG. 9.

The cached results are retrieved and those of the entries which do not match the search criteria are filtered out. The result of the request may be obtained from the union of results of multiple cached requests corresponding to the individual sub-requests. The cached results are retrieved and, again, those of the entries which do not match the search criteria are filtered out. Moreover, the redundant results are merged at step 520.

For example, a request R(att,ft,sc,bo) may be decomposed into two sub-requests SR. The sub-request SR1 comprises the attribute att1 and the sub-filter ft1 complementary to the attribute att4 and the sub-filter ft4 of the sib-request SR4. Thus, the union of SR1 and SR4 is done without overlapping. Then, the request filter is decomposed into a set of sub-filters corresponding to sub-results. Individual sub-results can be contained in some existing cached request. The results of the request is the union of the sub-results. If the same entry appears multiple times in the union, entries are merged (redundancy resolution).

As indicated, it is up to the cache manager to determine whether submission and merge of multiple sub-requests is more efficient than forwarding the entire original request to one of the proximal directory servers.

Moreover, the entries do not necessary need to have all the attributes specified in the filter expression. Thus, LDAP entries matching a filter can be taken from the cache even when every attribute specified in the attribute list is not present in the entry. A request with a filter like E1-e9, and an attribute list like E1-e10, is equivalent to a union of sub-requests, each having the same filter but complementary attribute list, e.g. E1-e11. For example, if a given entry belongs to a known objectclass that has required attributes, it is assumed that at least one value exists for each required attribute. Thus, a filter clause of the form E1-e12 is always true.

Advantageously, the entry storage avoids redundant storage of results in the cache. It also enables a simple update when an entry is modified or deleted. Moreover, the decomposition of results into entries increases the number of requests to which the cache manager can answer.

In an embodiment of the invention, to find sub-results, the sub-requests may be firstly normalized. During the possible normalization procedure, the cache manager may detect if the filter expression can be altered to render the request containment or inclusion detection easier. (In other words, the normalization operation may be spread).

In a possible alternative embodiment, a filter, e.g. E1-e7, designating a mandatory attribute for a specific objectclass may be modified into a postfixed expression, e.g. E1-e8, designating the specific objectclass and the mandatory attribute. This postfixed expression is possible if the mandatory attribute does not belong to any other objectclass defined in the LDAP schema. Thus, with the postfixed expression, if a request designating this specific objectclass is cached, it is easier to detect if a result associated with the cached request corresponds to the filter designating a mandatory attribute.

This invention is not limited to the above described embodiments.

To enable the cache to be accessed by result and then to enable retrieval of every entries matching the result, an index scheme may be implemented.

In another alternative embodiment, an administrative (dedicated) attribute may be added to every cached entry to indicate that the cached result is part of the LDAP search capabilities of the cache, and may be then used to retrieve the cached entries.

On another hand, a cache system may be provided for in the directory server, rather than in the Directory Access Router, which is an optional component. Locating it in the front end of the directory server avoids loading the internal functions of the directory server unnecessarily. More generally, the functions of the cache system may be distributed within the directory server system.

### Exhibit E1

e1. dn:cn=Sylvain o=SUN.com
e2 dn:commonName=Sylvain, organizationName=SUN.com.
e3. [cn=Sylvain+age=20], o=SUN.com
e4. [age=20+commonName=Sylvain], o=SUN.com.
e5. [age=20+commonName=Sylvain]
e6. AND (age=20) (commonName=Sylvain)
e7. (att1=<some value>)
e8. AND (objectclass=oc1) (att1=<some value>)
e9. (uid=Sylvain)
e10. (objectclass=uid)
e11. (entries matching uid=Sylvain having both attributes objectclass and uid)+(entries matching uid=Sylvain+having only attribute objectclass)+(entries matching uid=Sylvain+having only the only uid attribute)+(entries matchind uid=Sylvain with objectclass and uid attributes missing)+=union
e12. (required-att=*)

1. A directory server component, for use with a request query (420) adapted to receive an input request from a client (100) and to retrieve corresponding result data from a data base (302),
said directory server component comprising:
a cache manager (240) capable of storing sets of data, each set of data comprising request identifying data (R1, R2, R3) and corresponding result data (Q1, Q2, Q3), and
a request manager (410), capable of responding to an input request for searching request identifying data that match the input request, and of subsequently deciding whether result data in said sets of data will be at least partially used to answer the request.

2. The directory server component of claim 1, wherein the request manager (410) is capable of dividing an input request (R) into two or more sub-requests (SR), of individually searching each sub-request in the request identifying data, and of subsequently deciding which ones of the sub-requests will be answered using result data in said sets of data.

3. The directory server component of claim 2, wherein the sub-requests are complementary to each other.

4. The directory server component of claim 2, wherein the request manager is capable of firstly analyzing the input request (R) for deciding whether to initially operate on the input request (R), or on sub-requests (SR) thereof.

5. The directory server component of claim 2, wherein the request manager is capable of:
retrieving result data in the sets of data of the cache manager for first ones of the sub-requests (SR1), and
retrieving result data for second ones of the sub-requests (SR2) by calling the request query (420).

6. The directory server component as claimed in any of claims 1 through 5, wherein the request manager (410) uses a request comparator (400), capable of responding to a comparator input request for searching request identifying data that match the comparator input request.

7. The directory server component as claimed in any of claims 2 through 6, comprising a function adapted to transform an input request or sub-request into a form suitable for comparison with the request identifying data in said sets of data.

8. The directory server component of claim 7, wherein said function is called by the request manager when searching request identifying data that match an input request or sub-request.

9. The directory server component of claim 1, wherein the cache manager (240) is arranged for storing new sets of data, pursuant to incoming new input requests.

10. The directory server component of claim 9, wherein the cache manager (240) is arranged for storing new sets of data, pursuant to incoming new input requests, depending upon the decision of the request manager (410).

11. The directory server component as claimed in any of claims 1 through 10, wherein the request manager (410) is arranged to further compare an estimate cost function of the search in the cache manager with an estimate cost function of the search in the data base, and to make a decision pursuant to that further comparison.

12. The directory server component as claimed in anyone of the preceding claims, wherein the input request and the request identifying data comprise request elements such as a base object (bo), a scope (sc), a filter (ft) and an attribute list.

13. A method of processing requests in a directory server, comprising the following steps:
a. storing sets of data in a cache memory, said sets of data comprising request identifying data (R1, R2, R3) and corresponding result data (Q1, Q2, Q3), and
b. responsive to an input request received from a client, deciding whether result data in said sets of data will be used to serve the input request.

14. The method of claim 13, wherein step b. comprises determining from the request identifying data (R1, R2, R3) whether the cache contains results that match the request.

15. The method of claim 13 or 14, wherein step b. further comprises:
b1. dividing an input request (R) into two or more sub-requests (SR),
b2. determining from the request identifying data (R1, R2, R3) whether the cache contains results that match the sub-requests, and
b3. deciding which ones of the sub-requests will be answered using result data in said sets of data.

16. The method of claim 15, wherein the sub-requests are complementary to each other.

17. The method of claim 15, wherein step b. comprises firstly analyzing the input request (R) for deciding whether to initially operate on the input request (R), or on sub-requests (SR) thereof.

18. The method of claim 14, further comprising the step of:
c. at least partially executing the request, to retrieve those of the results that are not obtained from result data in said sets of data.

19. The method of claim 18, further comprising the step of
d. pursuant to step c. deciding whether to store the results being retrieved as new sets of data in the cache.

20. The method as claimed in any of claims 13 through 19, wherein step b. comprises transforming an input request or sub-request into a form suitable for comparison with the request identifying data in said sets of data.

21. The method as claimed in any of claims 13 through 19, wherein step b. comprises comparing an estimate cost function of the search in the cache manager with an estimate cost function of the search in the data base, and making a decision pursuant to that further comparison.

22. The method as claimed in any of claims 13 through 20, wherein the input request and the request identifying data comprise request elements such as a base object (bo), a scope (sc), a filter (ft) and an attribute list.

23. The method as claimed in any of claims 13 through 22, wherein step a. further comprises marking results being cached with a dedicated attribute.

24. A software product, comprising the software functions used in the directory server component as claimed in any of claims 1 through 12.

25. A software product, comprising the software functions for use in the method as claimed in any of claims 13 through 23.

26. A directory access router, having a directory server component as claimed in any of claims 1 through 12.

27. A directory server, having a directory server component as claimed in any of claims 1 through 12.

28. The directory server of claim 27, wherein the directory server component is located in the front-end of the directory server.
